(19) United States
(12) Patent Application Publication
(10) Pub. No.: US 2026/0219448 A1
(43) Pub. Date: Jul. 30, 2026

(54) OPTICAL INTERFACING DEVICE WITH AN ARRAY OF TAPERED OPTICAL FIBERS

(71) Applicant: IONQ INC., College Park, MD (US)

(72) Inventors: Chawina De-Eknamkul, Watertown, MA (US); Daniel Riedel, Somerville, MA (US); Bartholomeus Johannes Machielse, Brighton, MA (US)

(73) Assignee: IONQ INC., College Park, MD (US)

(21) Appl. No.: 19/040,202

(22) Filed: Jan. 29, 2025

(51) Int. Cl. G02B 6/122

(52) U.S. Cl. CPC G02B 6/1228

(57) ABSTRACT

Methods and systems for constructing and utilizing an optical interfacing device are disclosed. The device includes an array of optical fibers that are secured into a support structure, such that they are then pre-aligned with respect to one another and remain in place within the volume of the support structure. The optical fibers are also tapered by using wet or dry etching processes. The pre-aligned optical interfacing device is then aligned and coupled to optical elements within another optical or photonic device, thus enabling adiabatic coupling between the tapered ends of the optical fibers of the optical interfacing device and the optical elements of the other device. This ensures consistent transportation of light between the two devices.

### TECHNICAL FIELD

The present disclosure relates to methods and systems for a packaged optical interfacing device with an array of tapered optical fibers.

### BACKGROUND

Extracting light from optical and photonic devices remains a challenge due to enormous amounts of insertion loss at junctions such as grating couplers and end fire couplers. This, in combination with difficulties in aligning those junctions and subsequently maintaining stable and consistent alignment in cryogenic or otherwise exotic environments limits both efficiency and the use of those junctions to many technologically advanced applications within optics and photonics.

### BRIEF DESCRIPTION OF THE DRAWINGS

FIG. 1A illustrates a top view of an optical interfacing device, wherein the given optical interfacing device has V-shaped grooves that are used to secure optical fibers in place, according to some embodiments.

FIG. 1B illustrates a side view of the optical interfacing device introduced in FIG. 1A, according to some embodiments.

FIG. 1C illustrates a zoom of one of the optical fibers introduced in FIG. 1A, according to some embodiments.

FIG. 2A illustrates a top view of another optical interfacing device, wherein the given optical interfacing device has rhombus-shaped grooves that are used to secure optical fibers in place, according to some embodiments.

FIG. 2B illustrates a side view of the optical interfacing device introduced in FIG. 2A, according to some embodiments.

FIG. 3A illustrates a top view of yet another optical interfacing device, wherein the given optical interfacing device is made of cured, ribbon forming adhesive that surrounds portions of the optical fibers to secure them into place, according to some embodiments.

FIG. 3B illustrates a side view of the optical interfacing device introduced in FIG. 3A, according to some embodiments.

FIGS. 4A, 4B, and 4C illustrate a process of constructing an optical interfacing device by fabricating V-shaped grooves into the support structure material and then installing the optical fibers, according to some embodiments.

FIGS. 5A, 5B, and 5C illustrate another process of constructing an optical interfacing device by fabricating rhombus-shaped grooves into the support structure material and then installing the optical fibers, according to some embodiments.

FIG. 6 is a flow diagram that illustrates a process of constructing an optical interfacing device and subsequently coupling optical fibers of the optical interfacing device to other optical elements of a photonic wafer, according to some embodiments.

FIG. 7A illustrates an alignment and coupling of tapered optical fibers of an optical interfacing device to a photonic wafer region of a quantum wafer, according to some embodiments.

FIG. 7B illustrates a top view of the aligned and coupled optical interfacing device and photonic wafer, according to some embodiments.

FIG. 7C illustrates a zoom in of the photonic wafer region of the quantum wafer introduced in FIG. 7A, according to some embodiments.

FIG. 8 is a block diagram that illustrates an example computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. It is to be understood that the disclosed embodiments are merely examples and other embodiments can take various and alternative forms. The drawings are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments.

As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof. Furthermore, words such as “first,” “second,” “third,” etc. are meant to be used to distinguish a “first” element with respect to a “second” element, and so on, and should not be interpreted as limiting, but merely as a chosen naming convention for ease of discussion herein.

### DETAILED DESCRIPTION

The present disclosure relates to methods, apparatuses, and systems for constructing and utilizing an optical interfacing device. The optical interfacing device include a series, or array, of tapered optical fibers that are secured into a support structure. By securing the tapered optical fibers, the optical fibers remain aligned with respect to one another during future alignments of the optical interfacing device to optical elements of other photonic or optical devices. In some embodiments, un-tapered optical fibers are secured to the support structure, and then tapered simultaneously during a tapering process, such that the optical fibers are aligned relative to one another. This minimizes the amount of realignments and independent manipulations of each optical fiber in the future. Furthermore, the processes described herein for tapering the optical fibers provides adiabatic coupling between the tapered ends of the optical fibers and other optical elements, thus ensuring that stable, reliable, and loss-loss transportation of light is enabled.

The fraction of light that is lost during coupling from optical fibers to other photonic or optical devices is referred to as “insertion loss,” and is a key parameter that defines functionality of a given photonic or optical device. The methods and devices described herein limit this insertion loss, thus ensuring transportation of light between devices.

Previous attempts to couple photonic and optical devices to one another (e.g., without the tapered optical fibers described herein) used grating couplers or end fire couplers. Grating couplers, however, have a low efficiency of around 3 dB. This efficiency value is too low to be applied in quantum applications, such as those described herein. Moreover, grating couplers occupy a large area of a given chip's surface, and are also limited by the optical fibers needing to be vertically connected to the chip, thus severely limiting an amount of optical fibers that can be connected in total to the chip. End fire couplers have a sudden truncation of the optical structure such that light is sprayed from the end of the coupler. By aligning an optical fiber to the end of the optical structure, light may be extremely inefficiently collected. However, the geometric constraints further limit the practicality of such grating couplers or end fire couplers.

In contrast, the present disclosure pertains to an optical interfacing device that provides stable and reliable transportation of light via the tapered ends of a series of optical fibers. In embodiments, such a system includes the following: a photonic wafer; and an optical interfacing device, comprising: optical fibers with tapered ends, wherein the tapered ends are aligned with optical elements of the photonic wafer such that adiabatic coupling is enabled; and a support structure, wherein: first subsections of total lengths of the optical fibers are secured into a volume of the support structure; and second subsections of the total lengths of the optical fibers, comprising the tapered ends, remain exposed outside of the volume of the support structure. Moreover, the tapered ends of the optical fibers within the optical interfacing device comprise a core material of the optical fibers and no cladding material.

In additional embodiments, a method for constructing and utilizing optical interfacing devices is provided. The method includes: constructing an optical interfacing device, wherein the constructing comprises: securing first subsections of total lengths of optical fibers into a volume of a support structure, wherein second subsections of the total lengths of the optical fibers remain exposed outside of the volume of the support structure; and tapering the second subsections of the total lengths of the optical fibers such that the second subsections comprise tapered ends; and coupling the optical interfacing device to a photonic wafer such that adiabatic coupling is enabled between the tapered ends of the optical fibers and optical elements of the photonic wafer.

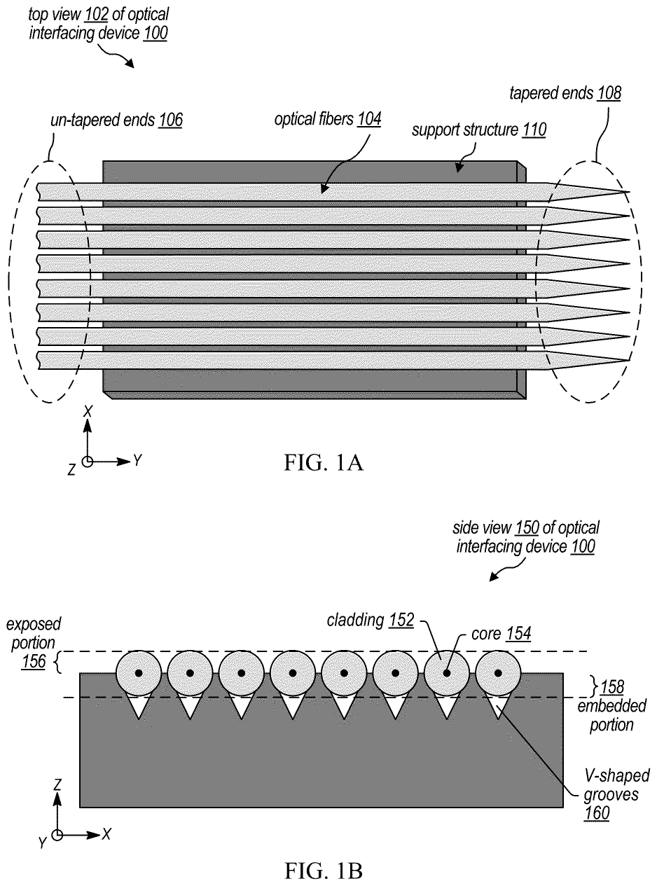

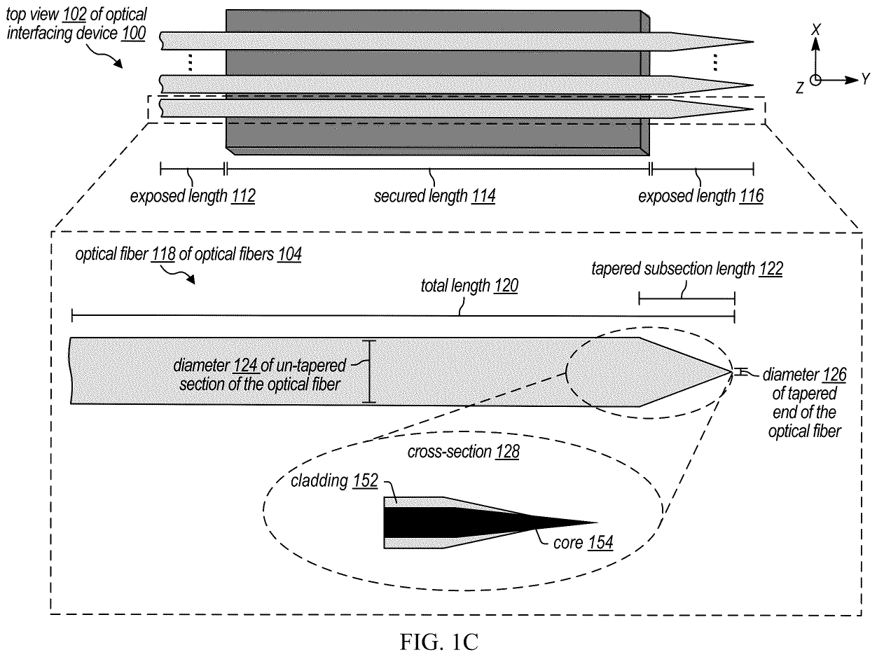

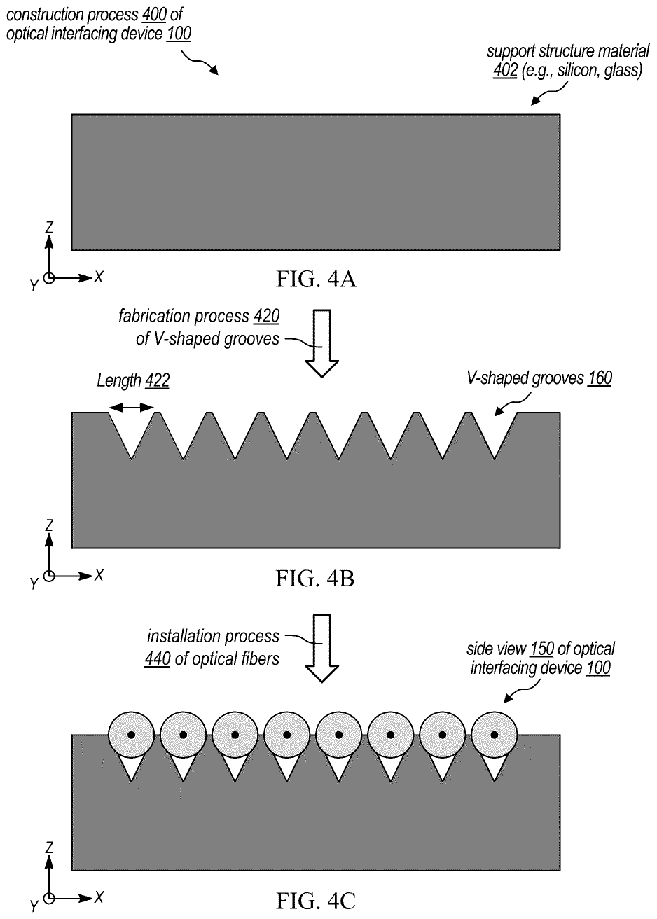

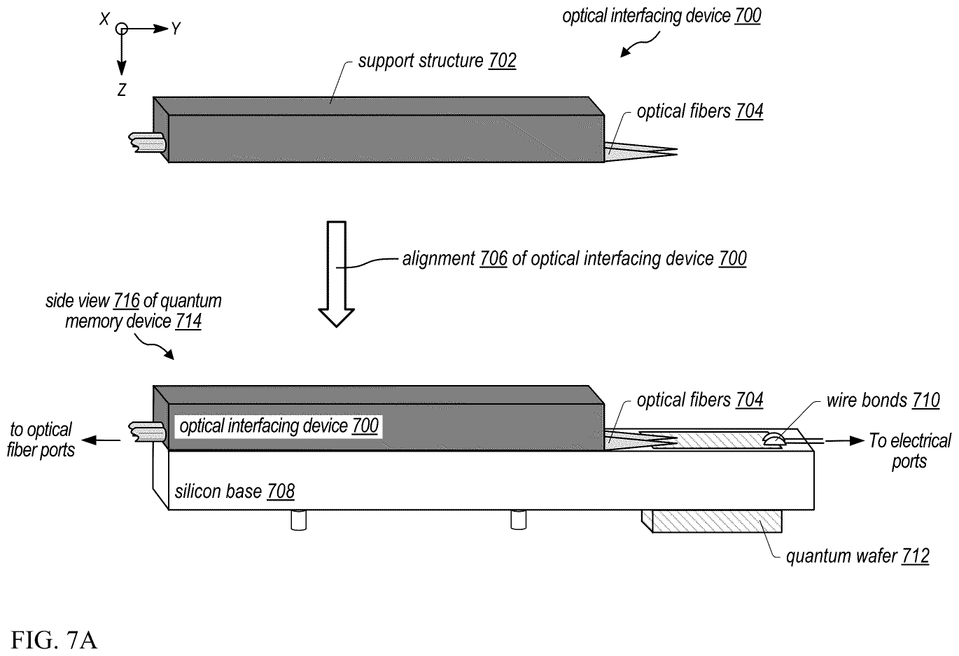

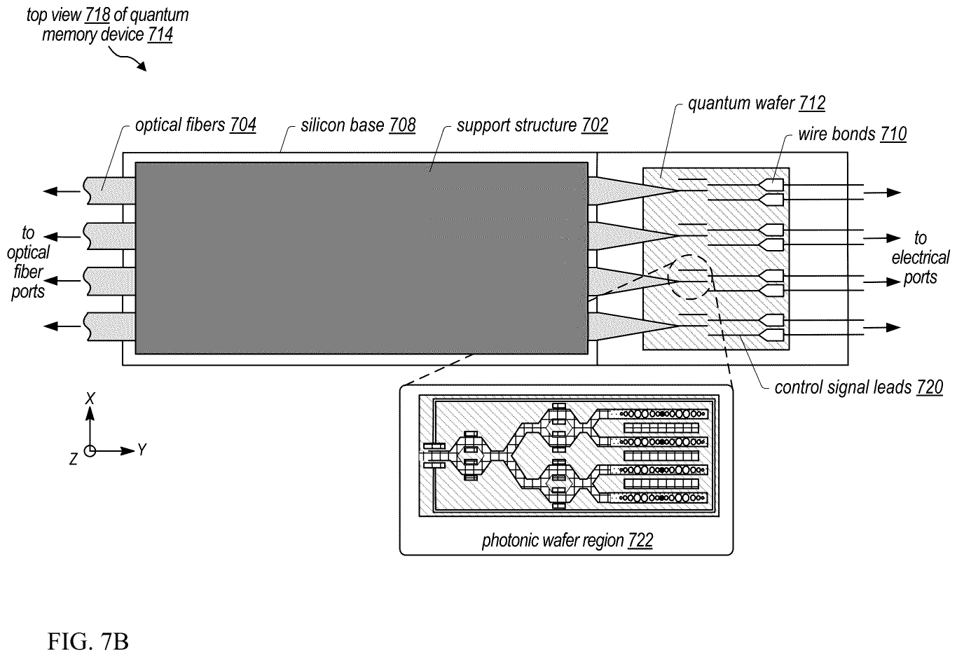

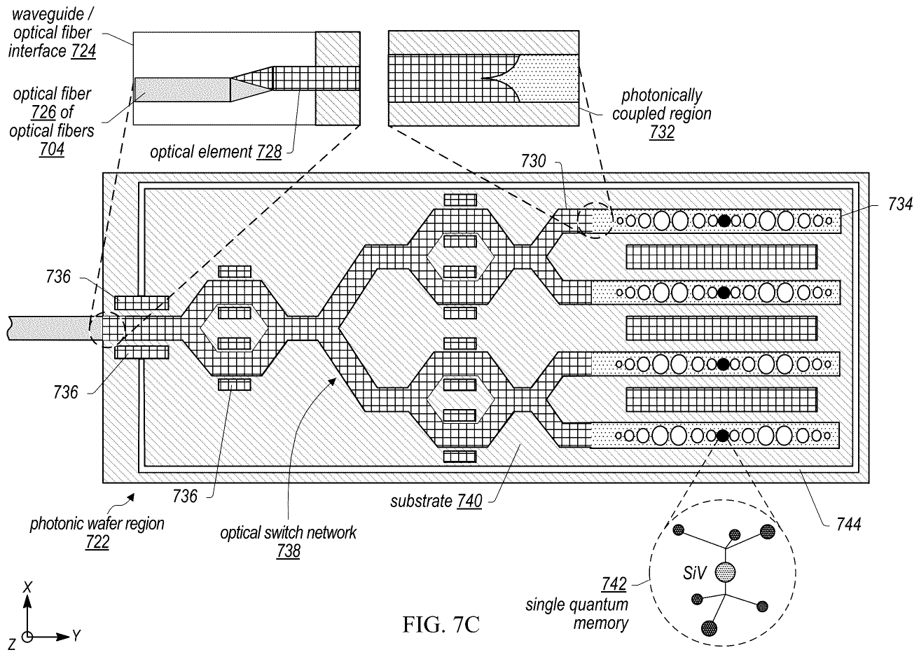

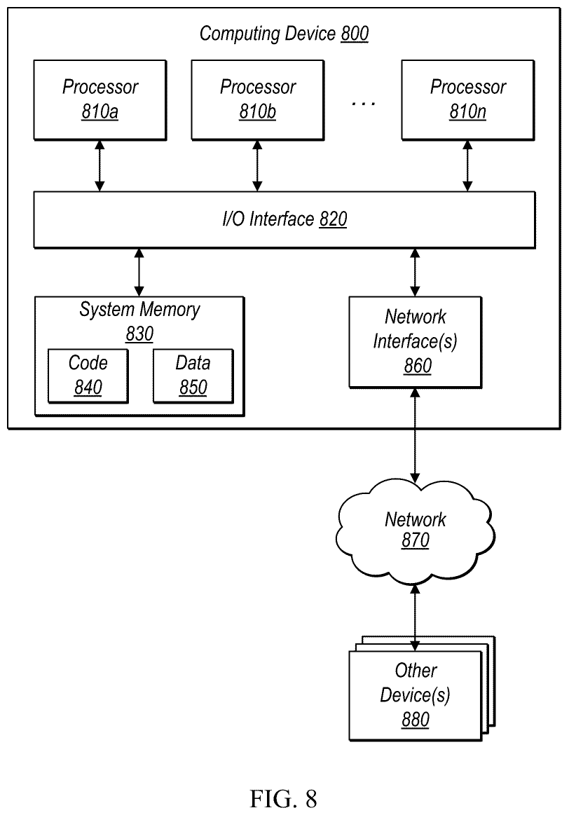

The present disclosure continues with examples of configurations of optical interfacing devices in FIGS. 1A-3B. Then, the construction of such types of optical interfacing devices is discussed with regard to FIGS. 4A-6. Next, the implementation of a given optical interfacing device that is configured to enable adiabatic coupling with a photonic wafer within a context of a quantum memory device is detailed in FIGS. 7A-7C. Finally, a description of an example computing system upon which the various components, modules, systems, and/or devices may be implemented is provided in FIG. 8. Various examples are provided throughout the specification. A person having ordinary skill in the art should understand that the previous and following description of constructing and subsequently utilizing optical interfacing devices is not to be construed as limiting as to the implementation of those processes, devices, or portions thereof.

Moreover, and as illustrated in the description that follows for FIGS. 1A-3B, an optical interfacing device, such as optical interfacing devices 100, 200, and 300, includes at least an array or series of optical fibers and a mechanical support structure to stabilize and secure those optical fibers. Throughout that description and the later description herein, X, Y, and Z axes are denoted throughout the figures. The use of X, Y, and Z axes is meant for ease of discussion herein in order to reference a given face or surface of such a three-dimensional structure with respect to another face or surface of the structure, and should not be misconstrued as specific to the sole orientation of such optical interfacing devices. Similarly, language such as “length,” “width,” and “thickness” are also used for ease of discussion herein in order to discuss one dimension with respect to another, and to convey approximate measurements of the various components of such three-dimensional structures. FIGS. 1A and 1B illustrate a top view and a side view, respectively, of an optical

interfacing device, wherein the given optical interfacing device has V-shaped grooves that are used to secure optical fibers in place, according to some embodiments.

As shown in the top view 102 (e.g., the XY plane) of optical interfacing device 100, the device includes at least a series of optical fibers 104 and a support structure 110. A total length of optical fibers 104 is larger than the Y axis dimension length of the support structure 110, such that (1) respective first subsections of optical fibers 104 are secured into a volume of the support structure 110 (see also secured length 114, illustrated in FIG. 1C), (2) respective second subsections of optical fibers 104 remain exposed outside of the volume of the support structure (see also exposed length 116, illustrated in FIG. 1C), and (3) respective third subsections of optical fibers 104 remain exposed outside of the volume of the support structure (see also exposed length 112, illustrated in FIG. 1C). Having the second and third subsections of optical fibers 104 located beyond

the boundaries of the support structure 110 ensures that both ends of optical fibers 104 are accessible for later installations, and enables one or both sets of ends of the optical fibers to be aligned and coupled to other optical or photonic devices. This is additionally illustrated in FIGS. 7A-7C and with the corresponding description herein.

Specifics regarding dimensions of optical fibers 104, of un-tapered ends 106, and of tapered ends 108 are illustrated in FIG. 1C and are additionally discussed below.

Moreover, particular embodiments illustrated in FIG. 1A show a series of eight optical fibers within optical fibers 104. However, in other embodiments, more or less optical fibers may be included within a given optical interfacing device, depending upon the intended implementation of that device. At least two optical fibers are included within the series of optical fibers. By installing the given plurality of optical fibers into the support structure and subsequently tapering them simultaneously, the optical fibers then have the same angle of tapering along the tapered ends, the same total lengths, the same portions of exposed lengths beyond the boundaries of the support structure, and same additional alignment properties with respect to one another.

Similarly, a distance along the X axis between two respective optical fibers may also be longer or shorter than that which is depicted in FIG. 1A, depending upon the intended implementation of that device.

As shown in the side view 150 (e.g., the ZX plane) of optical interfacing device 100, V-shaped grooves 160 have been etched, machined, or otherwise carved into a top surface of support structure 110, and respective ones of optical fibers 104 are secured into each of the V-shaped grooves. Furthermore, in the particular viewpoint illustrated in FIG. 1B, it may be understood that one is looking at a ZX plane of optical interfacing device 100 from a perspective of un-tapered ends 106. As such, both cladding 152 and core 154 are seen. Physical properties of optical fibers 104 are additionally discussed below, with regard to cross-section 128 in FIG. 1C.

Support structure 110 is configured with grooves, such as V-shaped grooves 160, that are used to secure optical fibers 104 and hold them in place, thus eliminating the need for future realignments of the optical fibers. Using a diameter of the un-tapered ends 106 as a reference (see also diameter 124 in FIG. 1C), a first portion of the diameters of the first subsections of optical fibers 104 are exposed above the top surface of support structure 110, as depicted by exposed portion 156, and a second portion of the diameters of the first subsections of optical fibers 104 are embedded within the volume of the support structure 110, as depicted by embedded portion 158. For example, exposed portion 156 and embedded portion 158 may each measure approximately half of diameter 124, according to some embodiments.

V-shaped grooves 160 may also be slightly confocal in their orientation, in which the tapered ends 108 of optical fibers 104 are thus oriented towards a common location. Configuring V-shaped grooves 160 to be confocal prepares tapered ends 108 to be aligned according to a pitch of optical elements on a given photonic wafer that optical interfacing device 100 may later be coupled to. An example of this alignment and coupling is described with regard to optical interfacing device 700, which is aligned and coupled to optical elements of photonic wafer region 722 in FIGS. 7A-7C.

Moreover, V-shaped grooves 160 may include a series of surface tension release substructures within respective ones of the locations of the grooves, which prohibits wicking of liquids up and along the optical-fiber-groove surfaces.

Support structure 110 may additionally be defined as a passive mechanical element that ensures that optical fibers 104 are held in a stable position with respect to one another. Support structure 110 may be made of silicon, glass, or some other similar type of material the enables the use of micromachining and/or lithography and etching techniques to carve grooves into a top surface of support structure 110. Such techniques are additionally described with regard to FIGS. 4A-6 herein.

Furthermore, support structure 110 may be approximately rectangular in shape, wherein a thickness (e.g., along the Z dimension in FIG. 1A) is between 0.5-1 millimeter, and the XY plane is oblong, or longer in the Y dimension than in the X dimension, for example. Support structure 110 may additionally be configured to have additional appendages or other grooves which allow for optical interfacing device 100 to be attached to an alignment tool.

FIG. 1C illustrates a zoom of one of the optical fibers introduced in FIG. 1A, according to some embodiments.

As shown in FIG. 1C, each of optical fibers 104 has an exposed length 112 that includes un-tapered ends 106, a secured length 114 that is secured into the volume of support structure 110, and another exposed length 116 that includes tapered ends 108. As additionally shown in the figure, secured length 114 is the same length of support structure 110 in the Y dimension. Moreover, the sum of exposed length 112, secured length 114, and exposed length 116 is equal to total length 120, which is illustrated with the given example of optical fiber 118 of optical fibers 104.

In the description herein of optical fibers 104, and in later description of optical fibers 204, optical fibers 304, and optical fibers 704, such optical fibers are defined as tapered optical fibers. “Tapered” ends refers to a conical or truncated conical termination of the optical fibers. As illustrated in FIG. 1C, tapered optical fibers include a tapered subsection length 122 in which a diameter 124 of an un-tapered section of optical fiber 118 linearly decreases to a diameter 126 of tapered end of optical fiber 112. The approximately linear decrease can occur at an approximately 3 degree angle.

In some embodiments, the tapered subsection length 122 is defined by a linear, or approximately linear, decrease in thickness across a distance in the Y dimension of approximately 100 micrometers to 10 millimeters. However, in other embodiments, other relationships between diameters 118 and 120 and subsection length 116 may be configured, such as quadratic or cubic decreases in thickness. This may depend upon the intended application of optical fibers 104 within a given optical interfacing device 100 in terms of future alignment and coupling with a photonic wafer, or with another photonic or optical device.

As illustrated in FIG. 1C, exposed length 116 is greater than tapered subsection length 122, such that respective portions of the optical fibers 104 maintain a diameter equal to diameter 124 prior to the tapered portions defined by tapered subsection length 122. For example, exposed length 116 is equal to 20 millimeters and tapered subsection length 122 is 5 millimeters, such that there is a 15 millimeter portion of exposed length 116 wherein the optical fibers are still un-tapered, before the tapered portion begins. In other embodiments, however, exposed length 116 is equal to tapered subsection length 122, or even smaller than tapered subsection 122 (e.g., wherein a portion of the optical fibers within secured length 114 have a diameter that is smaller than diameter 124).

In embodiments described herein, exposed length 116 may range from greater than 100 micrometers to less than 30 millimeters, while tapered subsection length 122 may range from greater than 100 micrometers to less than 10 millimeters. Moreover, diameter 126 of the tapered end of optical fiber 118 may, for example, be greater than 10 nanometers and less than 1 micrometer at the finest point of the tapered end. Furthermore, and with reference to one another, diameter 124 of the un-tapered section, which is secured into the volume of support structure 110, is at least one order of magnitude larger than diameter 126. For example, diameter 124 may be approximately 125 micrometers, which includes both core and cladding materials of the optical fibers.

In addition, the description herein that pertains to optical fibers refers to single-mode, optical and telecom fibers that are graded for quantum-based applications (e.g., wherein the optical fibers are configured to transfer light such that entangled photons may interact with quantum memories that have been patterned into a photonic wafer—see also FIGS. 7A-7C herein). For example, optical fibers 104 may refer to Corning® SMF-28® Ultra Optical Fibers, to Thorlabs© S630-HP Single Mode Optical Fibers, or some other similar type of single-mode optical or telecom fiber. Furthermore, optical fibers 104 may be made of pure silica and doped silica (e.g., fluorine-doped silica), or optical fibers 104 may be polymer-based fibers, or other glass-based fibers. In yet other embodiments in which polarization-maintaining fibers are implemented as optical fibers 104, PANDA single mode, polarization-maintaining fibers may be used, with stress rods located around the core material of such fibers. In such embodiments, optical fibers 104 may refer to Thorlabs© PM-S630-HP Single Mode Optical Fibers, or some other similar type of polarization-maintaining fiber.

For ease of discussion within the present disclosure herein, optical fibers, such as optical fibers 104, are referenced in terms of their “cladding” and “core” layers, such as cladding 152 and core 154 in FIGS. 1A and 1C. These terms are used to describe a core layer, or most interior layer of the optical fiber, that is then surrounded by an inner cladding layer, or second-most interior layer of the optical fiber, respectively. One or more additional layers that surround the inner cladding layer may also be present within the overall physical construction of the optical fiber based, at least in part, on the given single-mode optical or telecom fiber that is selected for implementation into a given optical interfacing device. Those additional layers may refer to a third-most interior layer, such as an “outer” or “protective” cladding, and to an outermost layer, such as a “jacket” or “coating,” etc.

In some embodiments, such as in types of single-mode optical fibers introduced above, core 154 may be made from un-doped silica, and the core 154 layer may have a diameter of approximately 3.5 micrometers. Continuing with such an example, cladding 152 may then resemble a bilayer, wherein cladding 152 itself includes multiple layers, a non-uniform profile of dopant, etc. For example, cladding 152 may include a fluorine-doped silica layer that surrounds core 154 and an un-doped silica layer that then surrounds the fluorine-doped silica layer, thus illustrating a bilayer cladding 152 design with a diameter of approximately 125 micrometers. Moreover, it is understood that a fluorine dopant is used to lower the refractive index in cladding 152 with respect to the refractive index in core 154.

In a second example, core 154 may be made of a doped silica material, such that the refractive index in core 154 is increased with respect to the refractive index in cladding 152. Examples of such dopants may include germanium, boron, aluminum, or phosphorus.

In a third example, using a polarization-maintaining optical fiber implementation of optical fibers 104, core 154 may also be made from un-doped silica, and the core 154 layer may have a diameter of approximately 3.5 micrometers. Cladding 152 may also be constructed as a bilayer of an inner fluorine-doped silica layer that surrounds core 154 and an un-doped silica layer that then surrounds the fluorine-doped silica layer. Furthermore, two stress rods may then also be embedded into the un-doped silica layer of cladding 152, wherein the stress rods are made from boron-doped silica with diameters of approximately 25 micrometers. The stress rods may be located approximately 30 micrometers from the center of core 154, according to some embodiments.

The above examples of various combinations of doped and un-doped materials that define core 154 and/or cladding 152 layers also pertains to various combinations that can be used to implement core 254 and cladding 152 of optical fibers 204, and those of core 352 and cladding 152 of optical fibers 304.

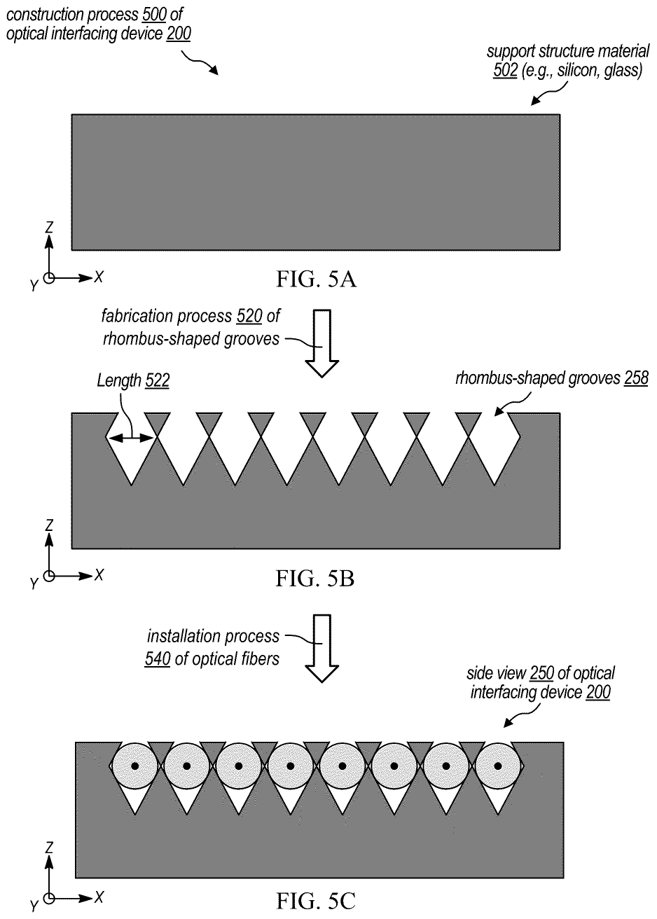

For purposes of the discussion herein, it should also be understood that any fourth or outermost layer has been removed from the optical fibers 104, for at least tapered subsection length 122, and prior to installation into support structure 110. In a first example, no “jacket” exists along the total length 120 of the optical fibers. As such, core 154, cladding 152, along with an outer cladding layer may be used to describe the physical construction of the optical fiber along exposed length 112 and secured length 114, and thus diameter 124 encompasses those three layers as well. Propagating this description to length 422 and length 522 in FIGS. 4 and 5, respectively, lengths 422 and 522 are equal to or slightly larger than diameter 124, wherein diameter 124 encompasses core 154 and cladding 152, along with the outer cladding layer, thus allowing for an optical fiber to be installed into each groove of the support structure. In a second example, a “jacket” exists along at least some portion of exposed length 112 and secured length 114, while the jacket has been removed from tapered subsection length 122. As such, core 154, cladding 152, the outer cladding layer, and the jacket may be used to describe diameter 124, and thus lengths 422 and 522 are also adjusted accordingly. The jacket may be made of polyethylene, polyvinyl chloride (PVC), or some other similarly mechanically robust type of material. As introduced above, core 154 may refer to a glass material, while cladding 152 may refer to a doped glass material, such that the refractive index of cladding 152 is higher than that of core 154. In other embodiments, core 154 may refer to a doped glass material, while cladding 152 may refer to an un-doped glass material, such that the refractive index of cladding 152 is lower than that of core 154, but a contrast between the two refractive indexes is still ensured.

For at least tapered subsection length 122 and up to the entirety of exposed length 116, however, the outer cladding layer is removed, such that simply cladding 152 and core 154 remain.

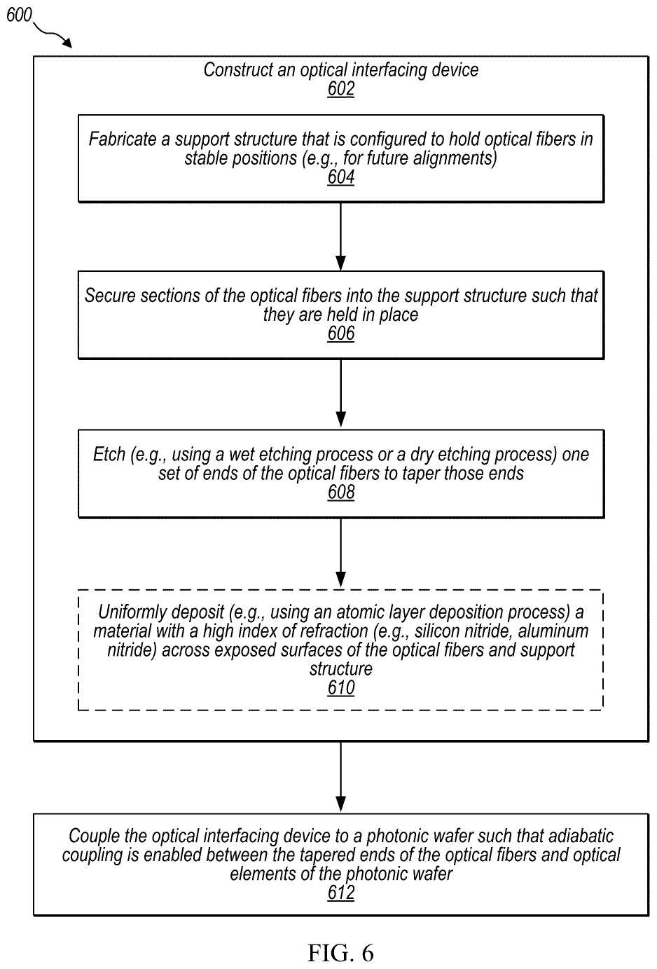

The outer cladding layer may be made of polyimide, acrylate, or some similar type of polymer that provides protection from moisture, strain, abrasion, etc., and has a diameter of approximately 250 micrometers. Thus, and in order to remove the outer cladding layer, exposed length 116 of the respective optical fibers 104 are submerged into a chemical solution (e.g., sulfuric acid), which has been heated to at least 200° C. (e.g., within a range of 200° C.-300° C.). Those portions of the optical fibers remain submerged for a given duration of time that is at least long enough to remove the outer cladding polymer material, leaving simply cladding 152 and core 154 material in the sections of the optical fibers defined by exposed length 116. This may be referred to herein as a first part of a tapering process of the second subsections of the optical fibers (e.g., the portions of the optical fibers that are exposed outside of the volume of the support structure). This tapering process is additionally described herein with regard to block 608 in FIG. 6.

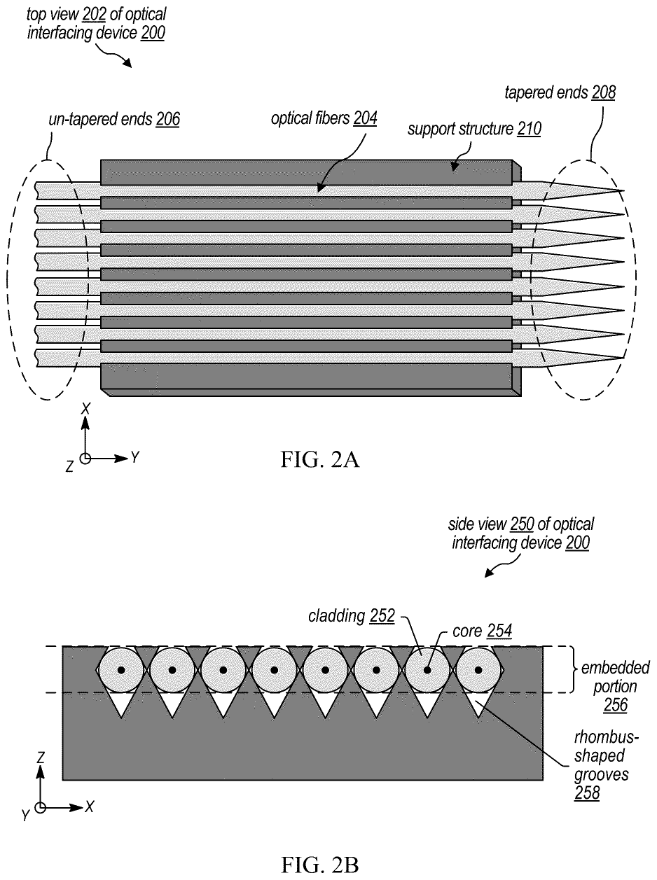

A result of the tapering process is additionally illustrated by cross-section 128 in FIG. 1C. Cross-section 128 shows a slice along the XY plane, perpendicular to the Z dimension. As shown along the Y dimension of cross-section 128, cladding 152 terminates slightly before the true tapered end of the optical fiber. As such, diameter 126 is a measurement of remaining core 154 layer, subsequent to the tapering processes described herein. As the glass material used for core 154 is the material at the true tapered end of optical fibers 104, this is the fundamental coupling element of optical fibers 104, and resembles the material used to make point of contact with an optical or photonic device in the future. This is additionally described with regard to FIGS. 7A-7C herein. FIG. 2A illustrates a top view of another optical interfacing device, wherein the given optical interfacing device has rhombus-shaped grooves that are used to secure optical fibers in place, according to some embodiments. FIG. 2B illustrates a side view of the optical interfacing device introduced in FIG. 2A, according to some embodiments.

As shown in the top view 202 (e.g., the XY plane) of optical interfacing device 200, the device includes at least a series of optical fibers 204 and a support structure 210. A total length of optical fibers 204 is larger than the Y axis dimension length of the support structure 210, such that (1) respective first subsections of optical fibers 204 are secured into a volume of the support structure 210 (see also secured length 114, illustrated in FIG. 1C), (2) respective second subsections of optical fibers 204 remain exposed outside of the volume of the support structure (see also exposed length 116, illustrated in FIG. 1C), and (3) respective third subsections of optical fibers 204 remain exposed outside of the volume of the support structure (see also exposed length 112, illustrated in FIG. 1C).

Having the second and third subsections of optical fibers 204 located beyond the boundaries of the support structure 210 ensures that both ends of optical fibers 204 are accessible for later installations, and enables one or both sets of ends of the optical fibers to be aligned and coupled to other optical or photonic devices. This is additionally illustrated in FIGS. 7A-7C and with the corresponding description herein.

Moreover, particular embodiments illustrated in FIG. 2A show a series of eight optical fibers within optical fibers 204. However, in other embodiments, more or less optical fibers may be included within a given optical interfacing device, depending upon the intended implementation of that device. At least two optical fibers are included within the series of optical fibers. By installing the given plurality of optical fibers into the support structure and subsequently tapering them simultaneously, the optical fibers then have the same angle of tapering along the tapered ends, the same total lengths, the same portions of exposed lengths beyond the boundaries of the support structure, and same additional alignment properties with respect to one another. Similarly, a distance along the X axis between two respective optical fibers may also be longer or shorter than that which is depicted in FIG. 2A, depending upon the intended implementation of that device. As shown in the side view 250 (e.g., the ZX plane) of optical interfacing device 200, rhombus-shaped grooves 258 have been etched, machined, or otherwise carved into a top surface of support structure 210, and respective ones of optical fibers 204 are secured into each of the rhombus-shaped grooves. Furthermore, in the particular viewpoint illustrated in FIG. 2B, it may be understood that one is looking at a ZX plane of optical interfacing device 200 from a perspective of un-tapered ends 206. As such, both cladding 252 and core 254 are seen. Physical properties of optical fibers 204 are additionally discussed with regard to cross-section 128 in FIG. 1C.

Support structure 210 is configured with grooves, such as rhombus-shaped grooves 258, that are used to secure optical fibers 204 and hold them in place, thus eliminating the need for future realignments of the optical fibers. Using a diameter of the un-tapered ends 206 as a reference (see also diameter 124 in FIG. 1C), total diameters of the first subsections of optical fibers 204 are embedded within the volume of the support structure 210, as depicted by embedded portion 256, such that total diameters of the optical fibers are flush with the top surface of support structure 210.

Rhombus-shaped grooves 258 may also be slightly confocal in their orientation, in which the tapered ends 208 of optical fibers 204 are thus oriented towards a common location. Configuring rhombus-shaped grooves 258 to be confocal prepares tapered ends 208 to be aligned according to a pitch of optical elements on a given photonic wafer that optical interfacing device 200 may later be coupled to. An example of this alignment and coupling is described with regard to optical interfacing device 700, which is aligned and coupled to optical elements of photonic wafer region 722 in FIGS. 7A-7C.

Moreover, rhombus-shaped grooves 258 may include a series of surface tension release substructures within respective ones of the locations of the grooves, which prohibits wicking of liquids up and along the optical-fiber-groove surfaces.

Support structure 210 may additionally be defined as a passive mechanical element that ensures that optical fibers 204 are held in a stable position with respect to one another. Support structure 210 may be made of silicon or some other similar type of material the enables the use of micromachining and/or lithography and etching techniques to carve grooves into a top surface of support structure 210. Such techniques are additionally described with regard to FIGS. 4A-6 herein.

Furthermore, support structure 210 may be approximately rectangular in shape, wherein a thickness (e.g., along the Z dimension in FIG. 1A) is between 0.5-1 millimeter, and the XY plane is oblong, or longer in the Y dimension than in the X dimension, for example. Support structure 210 may additionally be configured to have additional appendages or other grooves which allow for optical interfacing device 200 to be attached to an alignment tool.

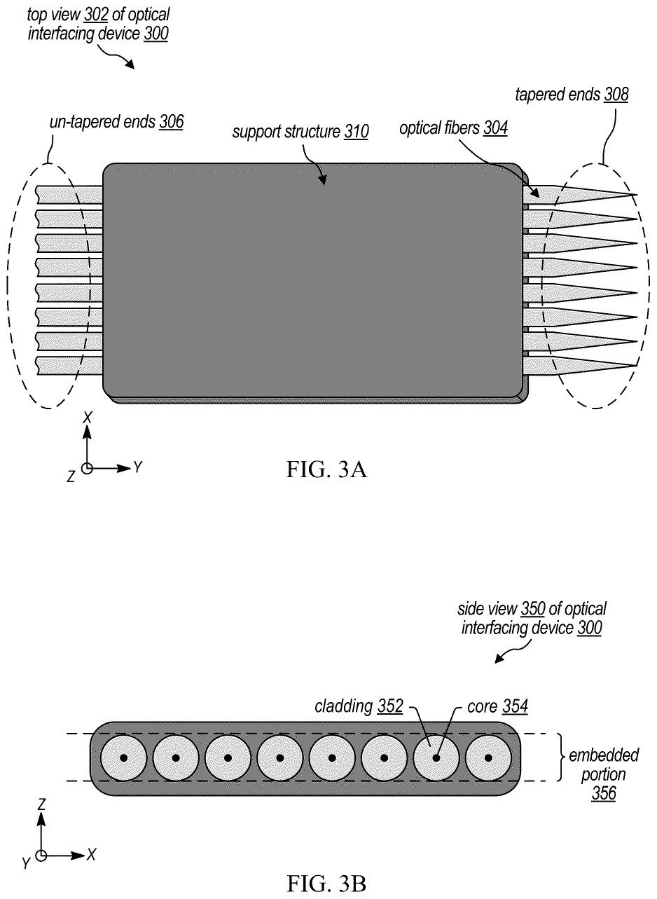

FIG. 3A illustrates a top view of yet another optical interfacing device, wherein the given optical interfacing device is made of cured ribbon forming adhesive that surrounds portions of the optical fibers to secure them, according to some embodiments. FIG. 3B illustrates a side view of the optical interfacing device introduced in FIG. 3A, according to some embodiments.

Support structures 110 and 210 primarily refer to volumes of silicon or glass, which can be etched, machined, or otherwise carved such that V-shaped grooves or rhombus-shaped grooves are formed into a top surface of the respective optical interfacing device. Support structures 110 and 210 may otherwise refer to other volumes of other materials, such as nickel, copper, Teflon, or graphite. In other embodiments, however, a support structure of the given optical interfacing device may be formed by using a liquid, ribbon forming adhesive that solidifies when cured. In such embodiments, optical fibers 304 are prearranged and aligned with respect to one another, and the liquid ribbon forming adhesive is then poured onto the first subsections of the total lengths of the optical fibers that are to be secured into the volume of the support structure. Once the ribbon forming adhesive has cured, it acts as a solidified volume that then holds the optical fibers 304 in place. The cured, ribbon forming adhesive surrounds the first subsections of the total lengths of the optical fibers.

As shown in the top view 302 (e.g., the XY plane) of optical interfacing device 300, the device includes at least a series of optical fibers 304 and a support structure 310, which is made of ribbon forming adhesive that has been cured. A total length of optical fibers 304 is larger than the Y axis dimension length of the support structure 310, such that (1) respective first subsections of optical fibers 304 are secured into a volume of the support structure 310 (see also secured length 114, illustrated in FIG. 1C), (2) respective second subsections of optical fibers 304 remain exposed outside of the volume of the support structure (see also exposed length 116, illustrated in FIG. 1C), and (3) respective third subsections of optical fibers 304 remain exposed outside of the volume of the support structure (see also exposed length 112, illustrated in FIG. 1C).

Having the second and third subsections of optical fibers 304 located beyond the boundaries of the support structure 310 ensures that both ends of optical fibers 304 are accessible for later installations, and enables one or both sets of ends of the optical fibers to be aligned and coupled to other optical or photonic devices. This is additionally illustrated in FIGS. 7A-7C and with the corresponding description herein.

Moreover, particular embodiments illustrated in FIG. 3A show a series of eight optical fibers within optical fibers 304. However, in other embodiments, more or less optical fibers may be included within a given optical interfacing device, depending upon the intended implementation of that device. At least two optical fibers are included within the series of optical fibers. By installing the given plurality of optical fibers into the support structure and subsequently tapering them simultaneously, the optical fibers then have the same angle of tapering along the tapered ends, the same total lengths, the same portions of exposed lengths beyond the boundaries of the support structure, and same additional alignment properties with respect to one another.

Similarly, a distance along the X axis between two respective optical fibers may also be longer or shorter than that which is depicted in FIG. 3A, depending upon the intended implementation of that device.

As shown in the side view 350 (e.g., the ZX plane) of optical interfacing device 300, it may be understood that one is looking at a ZX plane of optical interfacing device 300 from a perspective of un-tapered ends 306. As such, both cladding 352 and core 354 are seen. Physical properties of optical fibers 304 are additionally discussed with regard to cross-section 128 of tapered end in FIG. 1C.

As the cured, ribbon forming adhesive of support structure 310 secures optical fibers 304 and holds them in place, the need for future realignments of the optical fibers is eliminated. Using a diameter of the un-tapered ends 306 as a reference (see also diameter 124 in FIG. 1C), total diameters of the first subsections of optical fibers 304 are embedded within the volume of the support structure 310, as depicted by embedded portion 356.

Similarly to the orientation of V-shaped grooves 160 and rhombus-shaped grooves 258, optical fibers 304 may have been oriented in a confocal manner, prior to the curing of the liquid ribbon forming adhesive, in which the tapered ends 308 of optical fibers 304 are thus oriented towards a common location. By then allowing the ribbon forming adhesive to cure with this orientation of optical fibers 304, tapered ends 308 are then prepared to be aligned according to a pitch of optical elements on a given photonic wafer that optical interfacing device 300 may later be coupled to. An example of this alignment and coupling is described with regard to optical interfacing device 700, which is aligned and coupled to optical elements of photonic wafer region 722 in FIGS. 7A-7C.

FIGS. 4A, 4B, and 4C illustrate a construction process 400 of constructing an optical interfacing device by fabricating V-shaped grooves into the support structure material and then installing the optical fibers, according to some embodiments.

The given optical interfacing device 100 that is introduced in FIGS. 1A and 1B may be constructed by at least the following process steps. Generally speaking, the construction of optical interfacing device 100 includes at least (1) the fabrication process 420 of support structure 110, (2) the installation process 440 of optical fibers, and (3) the tapering of those optical fibers. Following at least those three process steps, the resulting optical interfacing device resembles that which is illustrated in FIGS. 1A and 1B.

Moreover, the tapering of the optical fibers may occur either before or after the installation of those optical fibers into grooves of the support structure. If the optical fibers are tapered after first securing them into grooves of the support structure, then tapered ends of the optical fibers are then mutually co-aligned by nature of being submitted to the same tapering process post-installation. This ensures that the tapered ends are mutually co-aligned after the fabrication process. If the optical fibers are tapered before securing them into grooves of the support structure, then the installation process step includes aligning the tapered optical fibers into the support structure with respect to one another, wherein the tapered ends of the optical fibers are aligned to within a 0.1 to 20 micrometers precision.

The tapering process of optical fibers is additionally described with regard to FIG. 6 herein. Such a process includes at least a first step of removing an outer cladding material from exposed length 116, as introduced above with regard to FIG. 1C.

As illustrated in FIG. 4A, an initial amount of support structure material 402 is used to fabricate support structure 110. The material 402 may be silicon, glass, or some other type of material that provides structural and mechanical support to the optical fibers 104.

Fabrication process 420 of V-shaped grooves then involves carving the grooves into the top surface of the support structure material 402. If support structure material 402 is made of silicon, then optical lithography may be used to define the V-shaped grooves and their spacing along the X, Y, and Z dimensions, according to the axes shown in the figure. Reactive ion or chemical etching is then used to transfer the patterns generated by optical lithography out of optical lithography resist and into the silicon support structure material 402. This is followed by a potassium hydroxide (KOH) etching or another crystallographic etching step that then etches the V-shaped grooves 160 into the top surface of the volume of the support structure material 402. In such embodiments, computer-based program instructions are provided to lithography and etching tools within a fabrication facility in order to perform such a fabrication process 420. (See also computing device 800 in FIG. 8.)

If, in other embodiments, support structure material 402 is made of glass, then computer-controlled machining processes that leverage some combination of drills, mills, or other mechanical tools are used to machine V-shaped grooves 160 into the top surface of the volume of the support structure material 402. Similarly, computer-based program instructions are provided to the various drills, mills, or other mechanical tools in order to perform such a fabrication process 420.

As additionally illustrated in FIG. 4B, length 422 defines a length along the X dimension of respective ones of V-shaped grooves 160. Length 422 may be equal to or slightly larger than diameter 124, thus allowing for an optical fiber to be installed into each groove.

Next, installation process 440 includes securing optical fibers 104 into V-shaped grooves 160. Installation process 440 may include at least securing optical fibers 104 into place within the V-shaped grooves 160 using small quantities of adhesives that are applied to portions of the optical fibers along secured length 114. In some embodiments, adhesive may be locally applied near the un-tapered ends 106, so as to ensure that the adhesive is located far from where liquids and or heat source(s) may be used in a subsequent tapering process of the optical fibers.

FIGS. 5A, 5B, and 5C illustrate a construction process 500 of constructing an optical interfacing device by fabricating rhombus-shaped grooves into the support structure material and then installing the optical fibers, according to some embodiments.

The given optical interfacing device 200 that is introduced in FIGS. 2A and 2B may be constructed by at least the following process steps. Generally speaking, the construction of optical interfacing device 200 includes at least (1) the fabrication process 520 of support structure 210, (2) the installation process 540 of optical fibers, and (3) the tapering of those optical fibers. Following at least those three process steps, the resulting optical interfacing device resembles that which is illustrated in FIGS. 2A and 2B.

Moreover, the tapering of the optical fibers may occur either before or after the installation of those optical fibers into grooves of the support structure. If the optical fibers are tapered after first securing them into grooves of the support structure, then tapered ends of the optical fibers are then mutually co-aligned by nature of being submitted to the same tapering process post-installation. This ensures that the tapered ends are mutually co-aligned after the fabrication process. If the optical fibers are tapered before securing them into grooves of the support structure, then the installation process step includes aligning the tapered optical fibers into the support structure with respect to one another, wherein the tapered ends of the optical fibers are aligned to within a 0.1 to 20 micrometers precision.

As illustrated in FIG. 5A, an initial amount of support structure material 502 is used to fabricate support structure 210. The material 502 may be silicon or some other type of material that provides structural and mechanical support to the optical fibers 204.

Fabrication process 520 of rhombus-shaped grooves then involves carving the grooves into the top surface of the support structure material 502. If support structure material 502 is made of silicon, then optical lithography may be used to define the rhombus-shaped grooves and their spacing along the X, Y, and Z dimensions, according to the axes shown in the figure. Reactive ion or chemical etching is then used to transfer the patterns generated by optical lithography out of optical lithography resist and into the silicon support structure material 502. This is followed by a KOH etching or another crystallographic etching step that then etches the rhombus-shaped grooves 258 into the top surface of the volume of the support structure material 502. In such embodiments, computer-based program instructions are provided to lithography and etching tools within a fabrication facility in order to perform such a fabrication process 520. (See also computing device 800 in FIG. 8.)

As additionally illustrated in FIG. 5B, length 522 defines a length along the X dimension of respective ones of rhombus-shaped grooves 258. Length 522 may be equal to or slightly larger than diameter 124, thus allowing for an optical fiber to be installed into each groove.

Next, installation process 540 includes securing optical fibers 204 into rhombus-shaped grooves 258. Installation process 540 may include at least securing optical fibers 204 into place within the rhombus-shaped grooves 258 using small quantities of adhesives that are applied to portions of the optical fibers along secured length 114. In some embodiments, adhesive may be locally applied near the un-tapered ends 206, so as to ensure that the adhesive is located far from where liquids and or heat source(s) may be used in a subsequent tapering process of the optical fibers.

FIG. 6 is a flow diagram that illustrates a process 600 of constructing an optical interfacing device and subsequently coupling optical fibers of the optical interfacing device to other optical elements of a photonic wafer, according to some embodiments.

As introduced above, constructing an optical interfacing device, as illustrated in block 602 in FIG. 6, includes at least three process steps: the fabrication of a support structure, as shown in block 604; the securing of sections of the optical fibers into the volume of the support structure, as shown in block 606; and the tapering of other sections of the optical fibers, as shown in block 608. Following the completion of the process steps shown in blocks 602, 604, 606, and 608, the resulting optical interfacing device may resemble embodiments shown in any of FIGS. 1A-3B, namely optical interfacing devices 100, 200, or 300. An additional, fourth step may also be incorporated in which a thin layer of a dielectric material is deposited onto exposed surfaces of the support structure and of the optical fibers. This is described below with regard to block 610.

In block 604, a support structure is fabricated such that it is configured to hold a series of optical fibers in place. The support structure may have a series of grooves that are etched, machined, or otherwise carved into a top surface of the overall volume of the support structure. For example, V-shaped grooves 160 are etched or machined into a starting material, resulting in a configuration such as optical interfacing device 100. In another example, rhombus-shaped grooves 258 are etched or machined into a starting material, resulting in a configuration such as optical interfacing device 200. In yet another example, a liquid ribbon forming adhesive is applied such that it surrounds sections of a given series of optical fibers. The adhesive is then cured, wherein the solidified ribbon forming adhesive thus functions as a support structure for the series of optical fibers, such as the configuration illustrated using optical interfacing device 300.

In block 606, first subsections of total lengths of the optical fibers are secured into the volume of the support structure. Following the above examples, optical fibers 104 may be secured into V-shaped grooves 160, or optical fibers 204 may be secured into rhombus-shaped grooves 258. In yet other examples of the liquid ribbon forming adhesive, blocks 604 and 606 are combined into a single process step, in which the curing of the ribbon forming adhesive both functions as a fabrication of the support structure step, and an installation of the optical fibers into the support structure step combined.

In block 608, the secured optical fibers are tapered, such that tapered ends 108, 208, or 308 are formed. As introduced above, the approximately linear (or quadratic, cubic, etc.) decrease in thickness across a tapered subsection length 122 enables the optical fibers to be used for adiabatic coupling to another photonic wafer or other optical device in the future. Such applications of adiabatic coupling of the tapered ends of the optical fibers are additionally described below with regard to FIGS. 7A-7C.

The tapering of one set of ends of the optical fibers involves several processing steps. A first processing step is to remove the outer cladding material from the subsections of the total lengths of the optical fibers that are to become the tapered ends of the optical fibers. As introduced above, those subsections of the optical fibers are submerged into a chemical solution, such as sulfuric acid, and which has been heated to at least 200° C. (e.g., within a range of 200°C.-300° C.), for a duration of time that is at least long enough to remove the outer cladding material, such that inner cladding material (e.g., cladding 152) and core material (e.g., core 154) remain. In the processing steps that follow, all optical fibers within the given series of optical fibers that are secured to the support structure of the optical interfacing device proceed through the processing steps simultaneously (e.g., all optical fibers are submerged into a chemical solution at the same time, and withdrawn from the chemical solution at the same time, due to the fact that they are already secured and aligned with respect to one another).

In some embodiments, the first processing step of removing the outer cladding material and subsequent processing steps that result in the tapered ends of the optical fibers being formed may be conducted using a fiber tapering device. The fiber tapering device is configured to provide mechanical support during those processing steps. In such embodiments, the support structure of the optical interfacing device is mounted onto the fiber tapering device, which is then configured to raise and lower the optical fibers of the optical interfacing device into and out of various chemical solutions with varying proximities.

The fiber tapering device includes a combination of mechanical stages that enable the repositioning of the mechanical support, the optical interfacing device, and various acids or liquids (e.g., chemical and water baths) with respect to one another. Relative motion along two axes are coarsely (e.g., with millimeter or centimeter scale accuracy) controlled, while relative motion along the third axis is controlled with nanometer or micrometer scale precision.

In a second processing step of block 608, an initial cleaning step is performed onto the optical fibers. For example, the second subsections of the total lengths of the optical fibers (e.g., tapered subsection lengths 122) are submerged into a cleaning solution, such as acetone, isopropyl alcohol (IPA), or a heated sulfuric acid solution. The subsections of the optical fibers may be agitated while submerged in the cleaning solution in order to ensure uniform cleaning. Moreover, intermediate immersion into water and optionally IPA may be applied in order to avoid mixing chemicals together that may react with one another. Similarly, such cleaning processes encompassed by the second processing step of block 608 may also vary according to an adhesive that is used to secure the optical fibers into the volume of the support structure, so as not to interfere with the properties of the adhesive.

In a third processing step of block 608, a wet etching process or a dry/vapor etching process may be used to decrease the thickness across the tapered subsection length 122, resulting in the formation of the tapered ends of the optical fibers.

In some embodiments in which a wet etching process is applied, the second subsections of the total lengths of the optical fibers are submerged into a chemical solution, and are then withdrawn from the chemical solution at a rate such that a linear (or quadratic, cubic, etc.) decrease in diameters of the optical fibers occurs. As introduced above, the un-tapered diameter 124 is at least one order of magnitude larger than the tapered end diameter 126 following completion of this wet etching processing step.

The chemical solution may include Hydrofluoric Acid (HF) (e.g., HF concentration of 49%) capped in either o-xylene, a mineral spirit or “white spirit,” or any other inert oil layer that sits on top of the HF in the chemical bath and through which an HF proof diffusion barrier is formed. Additional examples of the chemical solution may include HF-based mixtures such as HF and water (also referred to as diluted HF), HF and Hydrochloric Acid (HCl), or HF and ammonium fluoride (which would define the wet etching process in block 608 as a buffered oxide etching process).

Further considerations as to the type of chemical solution used may include whether or not a polarization-maintaining optical fiber is the type of optical fiber secured to the support structure: in such cases, using HF would additionally include an admixture of other acids, such as HCl or ammonium fluoride, in order to reduce sensitivity to variance in dopant concentration.

In such wet etching process steps of block 608, the resulting shape of the tapered end of the optical fiber depends on an initial diameter (e.g., diameter 124) of the un-tapered optical fiber, on an etching rate of the particular optical fiber with or without dopants within the inner cladding layer and/or core layer, and on the rate at which the optical fibers are withdrawn from the chemical solution. The concentration of the chemical solution, and the temperature of the chemical solution, in turn, determine the etching rate.

Moreover, doped silica cladding and/or core layers affects an etching rate of the optical fibers when submerged into the chemical solution (e.g., HF). For example, an etching rate of fluorine-doped silica is slightly lower than that of un-doped silica. The etching rates of index-raising dopants (e.g., germanium, boron, etc.) are higher than that of un-doped silica. Such material considerations of the inner cladding layer are also used to determine parameters of the given wet etching process being implemented in block 608. For example, a rate of withdrawal from the chemical solution may be engineered to be faster for optical fibers with a germanium-doped silica core layer and an un-doped inner cladding layer, in order to maintain an intended tapering angle, since germanium-doped silica is etched more quickly.

As such, and for a given initial diameter (e.g., diameter 124) of the un-tapered optical fiber, the temperature of the chemical solution, the concentration of the chemical solution, and the withdrawal rate of the optical fiber from the chemical solution are tuned in order to affect the tapering angle of the optical fiber along tapered subsection length 122.

In other embodiments of the third processing step of block 608, a dry or vapor etching process is used to decrease the thickness across the tapered subsection length 122, resulting in the formation of the tapered ends of the optical fibers. In some embodiments in which a dry or vapor etching process is applied, the support structure is suspended above a chemical solution for a duration of time, wherein the second subsections of the total lengths of the optical fibers are the ends facing the chemical solution bath. While the second subsections are suspended over the chemical solution, vapor escapes from a top surface of the chemical solution, which causes portions of the optical fibers to be etched away. Similarly to that which was introduced above with regard to a wet etching processing step, the duration of time that the second subsections are suspended above the chemical solution depends upon the concentration and temperature of the chemical solution. These factors are determined such that a linear (or quadratic, cubic, etc.) decrease in diameters of the optical fibers occurs. As introduced above, the un-tapered diameter 124 is at least one order of magnitude larger than the tapered end diameter 126 following completion of this dry or vapor etching processing step.

In such dry or vapor etching process steps of block 608, the chemical solution does not have a diffusion barrier (e.g., an inert oil) on the top surface of the bath. This allows vapor to escape from the top surface of the bath and into the atmosphere surrounding the second subsections of the total lengths of the optical fibers. The chemical solution used during dry or vapor etching process steps of block 608 may similarly include HF-based mixtures such as diluted HF, HF and HCl, HF and ammonium fluoride, etc.

In yet other embodiments of the third processing step of block 608, the optical fibers may be tapered by extruding them mechanically using heat and force. For example, the total lengths of the optical fibers are installed into two different support structures, such that there is an exposed portion (e.g., between 3 to 12 inches of fiber) of optical fibers in between the two different support structures. The exposed portions of the optical fibers are then inserted into a heating element (e.g., a flame, a plasma source, a ceramic heater, a carbon dioxide laser, or heated air), and the respective ends are pulled away from one another, using the support structures to stabilize this method. The heat source then partially melts the glass such that the fibers become thinner and thinner until they snap, thus forming two sets of tapered ends of the optical fibers, thus enabling the construction of two distinct optical interfacing devices with one heat pulling process step.

In a fourth processing step of block 608, the tapered optical fibers are cleaned. For example, they are rinsed in liquids (e.g., water, a solution that includes calcium to absorb the HF molecules, or a basic solution which counterbalances the PH of the surface) which are configured to halt any further etching of the tapered ends of the optical fibers.

In block 610, a dielectric material is uniformly deposited onto exposed surfaces of the optical fibers and the support structure. The dielectric material is a material such as silicon nitride, aluminum nitride, aluminum oxide, or any other similar type of dielectric material that has a higher index of refraction than silica. This processing step may be incorporated within an overall process of constructing an optical interfacing device in order to further limit any insertion loss when coupling the optical interfacing device to another photonic or optical device in the future. The dielectric material is deposited using a chemical vapor deposition technique, such as a plasma-enhanced chemical vapor deposition (PECVD) or even atomic layer deposition (ALD) technique in order to ensure enhanced control over deposition uniformity. As care is taken to ensure enhanced control over the deposition rate, thus resulting in a uniform deposition across all exposed surfaces, the deposited material will be a material that can be deposited by PECVD and/or ALD techniques (e.g., dielectric materials, not polymers). Moreover, the resulting deposited dielectric material has a thickness of 1 micrometer or less.

Following the completion of the construction of the optical interfacing device, the device may be aligned and coupled to optical elements of some other photonic or optical device, as indicated in block 612. As the tapered optical fibers are tapered using the processes discussed above, the tapered ends of the optical fibers enable the optical interfacing device to provide adiabatic coupling between the tapered ends and the optical elements of the other photonic or optical device. This is additionally described with regard to FIGS. 7A-7C and optical elements of photonic wafer region 722 below.

In the following FIGS. 7A-7C series described below, an optical interfacing device is aligned and coupled to a photonic wafer within a context of the transportation of entangled light particles for quantum memory applications. However, other embodiments of the present disclosure may apply the use of such optical interfacing devices for classical applications. As introduced above, insertion loss is a key parameter that currently limits the performance of many classical communications technologies and data center networks. At the time of writing, the current challenge for this community is to reduce per facet insertion loss from 2 dB to 0.5 dB. The tapering processes described herein, in combination with the construction process of the optical interfacing devices, ensures that the present disclosure can meet these demands, based on the ensured adiabatic coupling. In addition, a primary failure modality of data center hardware is the laser sources, which run at high power continuously, due to the high level of optical loss within the network. By reducing insertion loss of each device through methods described herein of improved adiabatic coupling, lower power lasers may be incorporated into data centers, thus improving the reliability of general data center technologies.

FIG. 7A illustrates an alignment and coupling of tapered optical fibers of an optical interfacing device to a photonic wafer region of a quantum wafer. FIG. 7B then illustrates a top view 718 of the aligned and coupled optical interfacing device and photonic wafer, while FIG. 7C illustrates a zoom in of the photonic wafer region of the quantum wafer introduced in FIG. 7A, according to some embodiments.

FIG. 7A depicts a side view 716 of an optical interfacing device 700 (and later of a quantum memory device 714), which includes an array of tapered optical fibers 704 which are secured into a volume of support structure 702. Optical interfacing device 700 may include any of the configurations introduced above, such as a silicon or glass support structure with V-shaped grooves or rhombus-shaped grooves for securing the optical fibers, or such as a cured ribbon forming adhesive that surrounds portions of the optical fibers, thus securing them in place.

An alignment process 706 is then conducted in which respective ones of the tapered ends of optical fibers 704 are aligned with optical elements of a photonic wafer region of quantum wafer 712, such that adiabatic coupling is ensured between optical interfacing device 700 and quantum wafer 712. Adhesive is then applied proximate to these junctions in order to ensure that alignment does not shift going forward.

Once optical interfacing device 700 is aligned and installed, the depiction in FIG. 7A may be referred to as a quantum memory device 714. The quantum memory device 714 includes optical interfacing device 700, silicon base 708 which optical interfacing device 700 is placed on top of, and quantum wafer 712. Quantum wafer 712, in turn, includes various photonic wafer regions that host quantum memory locations. By coupling optical interfacing device 700 to optical elements of those photonic wafer regions, light may be transported and thus received at the various quantum memory locations.

In some embodiments, quantum memories may be defined as optically active quantum memories that provide a method of receiving, storing, and providing quantum information. In some cases, quantum memories may be deployed for use in large-scale optical fiber networks or quantum entanglement networks, for example as quantum repeaters, that store and effectively connect distributed entangled particles to provide secure, long-distance communications. In such applications, quantum memory device 714 may function to control the tuning (e.g., adjustments to the local electrical, optical, thermal, electromechanical environment) of quantum memories housed within quantum memory device 714.

In some embodiments, a quantum memory device, such as quantum memory device 714, may comprise quantum memories and quantum memory control devices. Note that for ease of illustration, some embodiments of the following description are given in terms of quantum memory device 714 resembling a quantum repeater. However, in some embodiments, a quantum memory device may be used for other purposes, such as storing quantum information locally at a given location. For example, in some situations, quantum memory device 714 may be used to store quantum information (such as in a cache) that is used by multiple locally situated quantum computers. As seen in FIGS. 7B-7C, quantum wafer 712 may house quantum memories via photonic wafer regions such as photonic wafer region 722. Photonic wafer region 722 may resemble the depiction shown in FIG. 7C, and thus the functionalities enabled by the schematic layout of FIG. 7C (e.g., routing light between an optical fiber and respective quantum memories of the photonic wafer region 722) described herein.

Quantum memory control devices of quantum memory device 714 may, for example, provide mechanisms for receiving and routing quantum information (e.g., entangled particles) to be stored in the quantum memories of quantum wafer 712. In another example, quantum memory control devices may provide mechanisms for receiving, sending, emitting, and/or controlling optical and/or electrical control signals to, or from, quantum wafer 712. In yet another example, quantum memory control devices may modify the behavior of the quantum memories on quantum wafer 712 via the use of low-frequency control signals (e.g., microwave, radio frequency (RF), and/or DC control signals) that may induce strain on the quantum memories. Quantum memory control devices may additionally control heat and/or gas flow onto quantum wafer 712. Quantum memory control devices may also be used to deliver electrical control signals that result in the creation of local electromechanical strain fields near the quantum memories of quantum wafer 712, according to some embodiments. Such electromechanical strain fields may, for example, enable for the tuning of optical and/or spin properties of quantum memories on quantum wafer 712 for improved performance and operation of said quantum memories. This may be referred to as strain tuning of the quantum memories.

The placements and interactions of the quantum memories and some quantum memory control devices within quantum memory device 714 may resemble embodiments shown in the side view 716 and top view 718 of quantum memory device 714 in FIGS. 7A and 7B, respectively. In some embodiments, quantum memory device 714 may additionally include optical fiber ports and electrical ports that provide access points between optical fiber cables, control signal leads, electrical wires, electrical cables, etc., located external to quantum memory device 714, and to quantum wafer 712.

In some embodiments, quantum memory device 714 may include a base material, such as silicon base 708, onto which quantum wafer 712 may be bonded to or otherwise attached to. In some embodiments, as shown in FIGS. 7A-7B, the base material is silicon. However, it should be understood that the base material could be another material that provides similar functionalities as silicon base 708 (e.g., another semiconducting material).

Moreover, in some embodiments in which optical fiber 704 are secured into V-shaped grooves of support structure 702 and thus have an exposed portion of the diameters that extend beyond the base of the support structure 702 in the Z dimension, grooves may also be fabricated into silicon base 708, thus enabling a flush alignment of optical interfacing device 700 and silicon base 708.

As shown in FIG. 9B, optical fibers 704 may be coupled to quantum wafer 712 and to optical fiber ports of quantum memory device 714.

In addition, wire bonds, such as wire bonds 710 (e.g., soldering points), may be used to connect control signal leads 720 to electrical ports of quantum memory device 714. Electrical connections to quantum wafer 712 may also be fabricated using a “flip chip” method, according to some embodiments. In such embodiments, a “flip chip” layer may enable routing of electrical signals with complex topologies to quantum wafer 712. In some embodiments, electrical control signals, such as microwave or RF frequency control signals, may be used to control the state (e.g., state change) of a given quantum memory. In some embodiments in which the quantum memories on quantum wafer 712 are nanophotonic cavities (e.g., single quantum memory 742), DC or low-frequency AC electric fields may be used to tune the color center resonances of such nanophotonic cavities. In some embodiments, such electrical control signals may also be configured such that cross talk and excess heating of the quantum memories on quantum wafer 712 may be avoided. In some embodiments, electrical control signals, such as DC, RF, and/or microwave signals, may be delivered to the quantum memories of quantum wafer 712 via micro-patterned electrical lines (e.g., coplanar waveguides, capacitors, etc. that may be made of semiconducting and/or superconducting materials) on both silicon base 708 and quantum wafer 712 (e.g., control signal leads 720). For example, such micro-patterned electrical lines may be patterned using photonic waveguide layer 730.

In some embodiments, quantum wafer 712 may also include other types of devices on the same wafer such that quantum wafer is a densely packaged device. For example, photon detectors, frequency conversion nonlinear optics (e.g., nonlinear optical elements 736), and/or light sources on chip may be fabricated. In some embodiments, electromagnets may be provided on quantum wafer 712 (e.g., small, “on-chip” electromagnets) in order to fine-tune a local magnetic field environment of the quantum memories. Such “on-chip” electromagnets may be patterned onto quantum wafer 712 via photolithography and/or electron beam lithography fabrication processes.

In some embodiments, quantum memories on quantum wafer 712 may resemble single quantum memory 742. Quantum wafer 712 may comprise a “host material” for quantum memories (photonic waveguide layer 734), and may be micro-patterned for electrical lines that allow electrical control signals to reach the quantum memories, according to some embodiments. The materials chosen for quantum wafer 712 may vary based on the type of quantum memory it hosts. For example, quantum wafer 712 may resemble a nanophotonic crystal interface for a type of quantum memory such as a diamond SiV color center. However, quantum wafer 712 may resemble any nanophotonic cavity (e.g., nanophotonic crystal cavities, ring resonators, plasmonic cavities, etc.) or Fabry Perot cavity that provides an optical interface for quantum memories of quantum memory device 714, when used to house other types of quantum memories. The nanophotonic cavities may be attached to a variety of substrates, such as diamond, LiNbO, or silicon.

Once the type of nanophotonic cavity is chosen, quantum memory control devices are used to match the frequency of the nanophotonic cavity to the given quantum emitter (e.g., an entangled particle source). For example, the quantum memory control devices may be used to perform optical tuning (e.g., refractive index shift), electromechanical deformation tuning, and/or gas (e.g., N₂ gas) deposition tuning onto the nanophotonic cavities. In addition, control signal leads 720 may provide electrical control signals to, and/or from, the quantum memories and may be attached to quantum wafer 712 via wire bonds 710. In some embodiments, control signal leads 720 may be routed to respective nonlinear optical elements 736 via electrical routing paths such as electrical routing path 744 (e.g., electrical connections that have been patterned onto photonic wafer region 722, such as gold pads).

In some embodiments, photonic wafer region 722 may be used to transfer light between optical fiber 726, optical element 728, and respective quantum memories which may be patterned into photonic waveguide layer 734. In some embodiments, a process for fabricating at least some sub-regions of photonic wafer region 722 may use a starting stack, comprising substrate 740, and photonic waveguide layer 734, and photonic waveguide layer 730, may be patterned, resulting in the components shown in FIGS. 7A-7C. For example, photonically coupled region 732 may represent a sub-region of photonic wafer region 722 at which light may be transferred between photonic waveguide layer 730 and photonic waveguide layer 734. As shown in FIG. 7C, the two photonic waveguide layers of photonically coupled region 732 have been tapered to allow for evanescent coupling. In contrast, waveguide/optical fiber interface 724 may represent a sub-region of photonic wafer region 722 at which light may be transferred between optical fiber 726 and photonic waveguide layer 730 via optical element 728. In some embodiments, optical fiber 726 may interface with photonic waveguide layer 730 using adiabatic coupling, wherein tapered end of optical fiber 726 contacts a tapered end of optical element 728.

In some embodiments, an optical switch network, such as optical switch network 738, may be patterned into a material used to fabricate photonic waveguide layer 730. Optical switch network 738 may be used to route photons between waveguide/optical fiber interface 724 and photonically coupled region 732. It may be advantageous to design photonic wafer region 722 such that a single optical fiber services many individual quantum memories, as shown in FIG. 7C, and addressing incoming photons using optical switch network 738 enables photonic wafer region 722 to be a densely packaged device. In some embodiments, patterning optical switch network 738 into photonic waveguide layer 730 may be done in various ways. For example, in some embodiments in which the material for photonic waveguide layer 730 is selected for its electro-optic properties, it may be advantageous to maintain the photon in photonic waveguide layer 730 until the moment it is necessary to transfer the light into photonic waveguide layer 734 (e.g., storage in a given quantum memory patterned into photonic waveguide layer 734).

Photonic wafer region 722 may be configured to receive photons in a superposition state (e.g., via optical fiber 726) to an on-wafer storage (e.g., respective quantum memories patterned into photonic waveguide layer 734 such as single quantum memory 742). In some embodiments, quantum memories patterned into photonic waveguide layer 734 may be coupled to nanophotonic cavities, such as the nanophotonic cavity shown in single quantum memory 742, which illustrates a silicon vacancy in diamond structure. In such embodiments, the silicon vacancies are embedded into nanophotonic cavities within photonic waveguide layer 734, which may be diamond in such cases. A silicon vacancy in diamond structure, such as single quantum memory 742 demonstrated in FIG. 7C, may act as a quantum memory, and a corresponding nanophotonic cavity (e.g., patterned with diamond, etc.) may allow light to interface with said silicon vacancy in diamond structure. In other embodiments, however, quantum memories patterned into photonic waveguide layer 734 may resemble other structures embedded into photonic waveguide layer 734, such as nitrogen-vacancy in diamond, trapped atoms, ensemble doped crystals, atomic vapors, silicon carbide emitters, single rare earth dopants, trapped ions, superconducting qubits, quantum dots in gallium arsenide, defect centers in silicon or other semiconducting materials, etc. Furthermore, different types of quantum memories may be embedded into respective portions of photonic waveguide layer 734, and in some embodiments as shown in FIG. 7C, different materials may be used to respective photonic wafer regions (e.g., photonic wafer region 722) of quantum wafer 712, allowing respective photonic waveguide layers to be patterned according to a given quantum memory architecture.

In some embodiments wherein photonic wafer region 722 may be used within a quantum memory device, such as quantum memory device 714 (e.g., for use as a quantum network node for quantum entanglement distribution), photonic wafer region 722 may be configured to store a first received entangled particle of a first pair of entangled particles in a first single quantum memory 742 of photonic waveguide layer 734 and also store a second received entangled particle of a second pair of entangled particles in a second single quantum memory 742 of photonic waveguide layer 734.

Photonic wafer region 722 (or a quantum measurement device connected to photonic wafer region 722 either inside or outside of quantum memory device 714) may further be configured to perform one or more joint measurements on the first and second particles without collapsing superposition states of the first and second entangled particles. The joint measurements may determine a correlation relationship between the superposition states of the entangled particles such that entanglement can be extended between the pairs of entangle particles.

In some embodiments, quantum memories within photonic waveguide layer 734 may be heralded, meaning that when a particle arrives and is stored in a single quantum memory such as single quantum memory 742, a quantum measurement device issues a heralding signal announcing the arrival of the particle. In some embodiments, such a heralding signal may be issued via optical fiber 726, and may be used to trigger operation of an optical switch within optical switch network 738 in order to align the next pathway within optical switch network 738 for routing the next incoming particle to a respective quantum memory of photonic waveguide layer 734.

In some embodiments, photonic wafer region 722 may further include a conversion interface (e.g., nonlinear optical elements 736). For example, in some embodiments, a conversion interface (e.g., nonlinear optical elements 736) may convert a transmission frequency of a received photonic particle to a different frequency prior to storage of the particle in a given quantum memory within photonic waveguide layer 734. For example, in some embodiments, fiber optical links (e.g., optical fiber 726) may transmit photonic particles using different frequencies and such variations may be adjusted via a conversion interface of photonic wafer region 722. As another example, particles received at photonic wafer region 722 via optical ground stations and/or particles received at photonic wafer region 722 via fiber links may be transmitted at different wavelengths and a conversion interface of photonic wafer region 722 may convert the wavelength of the received particles to a wavelength used by a given single quantum memory, such as single quantum memory 742, to store quantum particles in said memory. In some embodiments, nonlinear optical elements 736, as shown in FIG. 7C, may also provide phase shifting, amplitude modulation, and/or other functionalities with respect a received particle, and/or any other interfacing property that may be required in terms of manipulating an incoming particle before routing the particle to storage on photonic wafer region 722. Furthermore, as shown in FIG. 7C, nonlinear optical elements 736 may also be fabricated using a same material as the material used to fabricate photonic waveguide layer 730, according to some embodiments.

FIG. 8 is a block diagram illustrating an example computing device that may be used in at least some embodiments.

FIG. 8 illustrates such a general-purpose computing device 800 as may be used in any of the embodiments described herein. In the illustrated embodiment, computing device 800 includes one or more processors 810 coupled to a system memory 830 (which may comprise both non-volatile and volatile memory modules) via an input/output (I/O) interface 820. Computing device 800 further includes a network interface 860 coupled to I/O interface 820.

In various embodiments, computing device 800 may be a uniprocessor system including one processor 810, or a multiprocessor system including several processors 810 (e.g., two, four, eight, or another suitable number). Processors 810 may be any suitable processors capable of executing instructions. For example, in various embodiments, processors 810 may be general-purpose or embedded processors implementing any of a variety of instruction set architectures (ISAs), such as the x86, PowerPC, SPARC, or MIPS ISAs, or any other suitable ISA. In multiprocessor systems, each of processors 810 may commonly, but not necessarily, implement the same ISA. In some implementations, graphics processing units (GPUs) may be used instead of, or in addition to, conventional processors.

System memory 830 may be configured to store instructions and data accessible by processor(s) 810. In at least some embodiments, the system memory 830 may comprise both volatile and non-volatile portions; in other embodiments, only volatile memory may be used. In various embodiments, the volatile portion of system memory 830 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 830 as code 840 and data 850.

In some embodiments, I/O interface 820 may be configured to coordinate I/O traffic between processor 810, system memory 830, and any peripheral devices in the device, including network interface 860 or other peripheral interfaces such as various types of persistent and/or volatile storage devices. In some embodiments, I/O interface 820 may perform any necessary protocol, timing or other data transformations to convert data signals from one component (e.g., system memory 830) into a format suitable for use by another component (e.g., processor 810). In some embodiments, I/O interface 820 may include support for devices attached through various types of peripheral buses, such as a variant of the Peripheral Component Interconnect (PCI) bus standard or the Universal Serial Bus (USB) standard, for example. In some embodiments, the function of I/O interface 820 may be split into two or more separate components, such as a north bridge and a south bridge, for example. Also, in some embodiments some or all of the functionality of I/O interface 820, such as an interface to system memory 830, may be incorporated directly into processor 810.

Network interface 860 may be configured to allow data to be exchanged between computing device 800 and other devices 880 attached to a network or networks 870, such as other computer systems or devices as illustrated in FIG. 1A through FIG. 7C, for example. In various embodiments, network interface 860 may support communication via any suitable wired or wireless general data networks, such as types of Ethernet network, for example. Additionally, network interface 860 may support communication via telecommunications/telephony networks such as analog voice networks or digital fiber communications networks, via storage area networks such as Fibre Channel SANs, or via any other suitable type of network and/or protocol.

In some embodiments, system memory 830 may represent one embodiment of a computer-accessible medium configured to store at least a subset of program instructions and data used for implementing the methods and apparatus discussed in the context of FIG. 1A through FIG. 7C. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 800 via I/O interface 820. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 800 as system memory 830 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 860. Portions or all of multiple computing devices such as that illustrated in FIG. 8 may be used to implement the described functionality in various embodiments; for example, software components running on a variety of different devices may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A system, comprising:
a photonic wafer; and
an optical interfacing device, comprising:
optical fibers with tapered ends, wherein the tapered ends are aligned with optical elements of the photonic wafer such that adiabatic coupling is enabled; and
a support structure, wherein:
first subsections of total lengths of the optical fibers are secured into a volume of the support structure; and
second subsections of the total lengths of the optical fibers, comprising the tapered ends, remain exposed outside of the volume of the support structure.

2. The system of claim 1, wherein:
the first subsections of the total lengths of the optical fibers are secured to rhombus-shaped grooves that are etched into a top surface of the volume of the support structure; and
the first subsections of the total lengths of the optical fibers are secured such that total diameters of the optical fibers are embedded within the volume, and the optical fibers are flush with the top surface of the support structure.

3. The system of claim 1, wherein:
the first subsections of the total lengths of the optical fibers are secured to V-shaped grooves that are etched into a top surface of the volume of the support structure; and
the first subsections of the total lengths of the optical fibers are secured such that a first portion of diameters of the optical fibers are embedded within the volume and a second portion of the diameters of the optical fibers are exposed above the top surface of the support structure.

4. The system of claim 1, wherein the lengths of the second subsections of the optical fibers are greater than 100 micrometers and less than 30 millimeters.

5. The system of claim 1, wherein:
diameters of the tapered ends are greater than 10 nanometers and less than 1 micrometer; and
other diameters of the first subsections, which are secured into the volume of the support structure, are at least one order of magnitude larger than the diameters of the tapered ends.

6. The system of claim 1, wherein:
the optical fibers are single-mode optical fibers; and
the optical fibers comprise a core layer that is surrounded by a cladding layer.

7. The system of claim 6, wherein:
the core layer comprises a silica material; and
the cladding layer comprises a doped silica material.

8. The system of claim 1, wherein the volume of the support structure is made of silicon.

9. The system of claim 1, wherein the volume of the support structure is made of glass.

10. The system of claim 1, wherein the volume of the support structure is made of ribbon forming adhesive that has been cured.

11. The system of claim 1, wherein:
the photonic wafer comprises a quantum memory location; and
the adiabatic coupling between the tapered ends of the optical fibers and the optical elements of the photonic wafer enables light to be received at the quantum memory location.

12. A method, comprising:
constructing an optical interfacing device, wherein the constructing comprises:
securing first subsections of total lengths of optical fibers into a volume of a support structure, wherein second subsections of the total lengths of the optical fibers remain exposed outside of the volume of the support structure; and
tapering the second subsections of the total lengths of the optical fibers such that the second subsections comprise tapered ends; and
coupling the optical interfacing device to a photonic wafer such that adiabatic coupling is enabled between the tapered ends of the optical fibers and optical elements of the photonic wafer.

13. The method of claim 12, wherein:
the volume of the support structure is made of silicon; and
the constructing the optical interfacing device further comprises:
etching rhombus-shaped grooves into a top surface of the volume of the support structure; and
the securing the optical fibers comprises installing the first subsections of the total lengths of the optical fibers into the rhombus-shaped grooves.

14. The method of claim 12, wherein:
the volume of the support structure is made of silicon; and
the constructing the optical interfacing device further comprises:
etching V-shaped grooves into a top surface of the volume of the support structure; and
the securing the optical fibers comprises installing the first subsections of the total lengths of the optical fibers into the V-shaped grooves.

15. The method of claim 12, wherein:
the volume of the support structure is made of glass; and
the constructing the optical interfacing device further comprises:
machining V-shaped grooves into a top surface of the volume of the support structure; and
the securing the optical fibers comprises installing the first subsections of the total lengths of the optical fibers into the V-shaped grooves.

16. The method of claim 12, wherein:
the securing the first subsections of the total lengths of the optical fibers into the volume of the support structure comprises curing liquid, ribbon forming adhesive that surrounds the first subsections of the total lengths of the optical fibers; and
the volume of the support structure is made of solidified, ribbon forming adhesive.

17. The method of claim 12, wherein the tapering of the second subsections of the total lengths of the optical fibers comprises:
submerging the second subsections of the total lengths of the optical fibers into a chemical solution; and
withdrawing the second subsections of the total lengths of the optical fibers from the chemical solution at a rate such that a linear decrease in diameters of the optical fibers occurs across at least 100 micrometers of the second subsections.

18. The method of claim 17, wherein the tapering of the second subsections of the total lengths of the optical fibers comprises:
tuning a temperature of the chemical solution, a concentration of the chemical solution, and the rate of the withdrawing such that a given tapering angle of the second subsections of the total lengths of the optical fibers is enabled.

19. The method of claim 12, wherein the tapering of the second subsections of the total lengths of the optical fibers comprises:
suspending the second subsections of the total lengths of the optical fibers above a chemical solution for a duration of time, wherein:
vapor that escapes from a top surface of the chemical solution causes portions of the optical fibers to be etched away; and
the duration of time is such that a linear decrease in diameters of the optical fibers occurs across at least 100 micrometers of the second subsections.

20. An optical interfacing device, comprising:
optical fibers with tapered ends, wherein the tapered ends enable adiabatic coupling;
a support structure, wherein:
first subsections of total lengths of the optical fibers are secured into a volume of the support structure; and
second subsections of the total lengths of the optical fibers, comprising the tapered ends, remain exposed outside of the volume of the support structure; and
a dielectric material that has been deposited onto exposed surfaces of the optical fibers and the support structure.
